(19) United States
(12) Patent Application Publication
(10) Pub. No.: US 2026/0233767 A1
(43) Pub. Date: Aug. 13, 2026

(54) SIGNAL SYSTEM SWITCHOVER METHOD, SYSTEM, DEVICE AND MEDIUM

(71) Applicant: CASCO SIGNAL LTD., Shanghai (CN)

(72) Inventors: Xiaoyong WANG, Shanghai (CN); Yanyang XING, Shanghai (CN); Wei FENG, Shanghai (CN); Jinhong XIONG, Shanghai (CN); Liang PAN, Shanghai (CN); Xiaoque LING, Shanghai (CN); Donghai WANG, Shanghai (CN); Shaowen CHEN, Shanghai (CN)

(73) Assignee: CASCO SIGNAL LTD., Shanghai (CN)

(21) Appl. No.: 19/115,764

(22) PCT Filed: Nov. 17, 2023
(86) PCT No.: PCT/CN2023/132172

§ 371 Date: Mar. 30, 2026

(30) Foreign Application Priority Data
Jul. 25, 2023 (CN) 202310916398.2

(51) Int. Cl. B61L 7/08

(52) U.S. Cl. CPC B61L 7/08

(57) ABSTRACT

A signal system switchover method, comprising: after a system is started, switchover an old system operates and a new system is in a shadow-mode operation state(step 1); the new system collects working states of tracksides and trains and sends the working states to a panoramic cab HMS (step 2); a self-synchronization subsystem TAS periodically synchronizes and loads a daytime formal operation plan of the old system to the new system (step 3); the panoramic cab KMS checks whether working modes of the tracksides and the trains are consistent, and automatically gives an alarm when the working modes are not consistent or a fault occurs (step 4); the new system automatically collects operation data in a shadow operation mode and stores the operation data to a line data pool (step 5). Also provided are s system using the signal switchover method, an electronic device, and a computer-readable storage medium.

### TECHNICAL FIELD

The present invention relates to a rail transit signal system, in particular to a signal system switchover method and system.

### BACKGROUND

A rail transit signal system is an important part of a rail transit automation control system, and it is a collection of technical measures and supporting equipment needed to realize train operation command, train operation monitoring and management. Its role is to command a train and ensure safe operation of the train. Urban rail transit has the characteristics of a high density, a short interval, a short station distance and a high speed, so it has requirements on a traffic support system, such as high safety requirements, large passing capacity, strong anti-interference ability, high reliability and high degree of automation.

With the deepening of technologies in the rail transit field, the rail transit signal system is constantly being upgraded and transformed. In the upgrading and transformation process of the rail transit signal system, an old system is usually used for operation during an operation period, and a new system is used for debugging only during a debugging period. After the debugging of the new system is complete, the system is cut over to the new system, and the train operation is controlled by the new system. This switchover method enables control of a line and the train by the existing system and the new system to have a clear boundary in time and space, in order to prevent the train operation from being wrongly controlled to bring safety risks.

However, the shortcoming brought by this method is that before the new system is officially put into passenger operation, it cannot carry out a full-time domain stress test of all trains on the whole line covering entire operation time, which brings a lot of uncertainties about whether the new system can meet an operation service quality after taking over the operation after switchover. This is particularly critical for the transformation and upgrading of busy and heavy-duty backbone hub lines. The existing switchover scheme is mainly reflected in a certain limitation on a dealing manner of a following strategy, safety isolation and quality monitoring between the old and new systems.

### SUMMARY

The present invention aims to provide a signal system switchover method and system for overcoming the defects in the prior art.

The purpose of the present invention can be realized by the following technical schemes:

According to a first aspect of the present invention, provided is a signal system switchover method, implemented based on an active following shadow mode and full-time domain quality monitoring, and specifically comprising the following steps:

step S1: a signal system is started, a working state is set to an old system working state and a new system shadow operating state, and step S2 is executed;

step S2: when the signal system is officially put into operation, an old system carries out normal operating control, and a new system obtains operating data of a line and a train, and step S3 is executed;

step S3: an automatic data collection module provides the operating data obtained by the new system to a trackside line data pool, and the line data pool provides the operating data to a central data lake, step S4 is executed;

step S4: a quality monitoring subsystem QMS automatically analyzes operating quality according to the operating data in the central data lake and transmits a result to a panoramic cockpit HMS, and step S5 is executed; and step S5: when debugging the signal system, the working state is set to a new system working state.

As a preferred technical scheme, the signal system in step S1 transmits working states of an all-line trackside system and a vehicle system to the panoramic cockpit HMS.

As a preferred technical scheme, in step S2, before the signal system is officially put into operation, an old system control center synchronizes an official operation plan to a new system control center through a self-synchronization subsystem TAS.

As a preferred technical scheme, when the signal system in step S2 is officially put into operation, the panoramic cockpit HMS checks the working states of the all-line trackside system and the vehicle system, and automatically alarms if any device is in the new system working state.

As a preferred technical scheme, in step S3, the line data pool unidirectionally receives the operating data of the trackside system and the vehicle system.

As a preferred technical scheme, in step S3, the data of the line data pool is unidirectionally fed to the central data lake.

As a preferred technical scheme, in step S4, the quality monitoring subsystem QMS carries out analysis based on data from the central data lake.

As a preferred technical scheme, in step S5, during debugging of the signal system, the automatic data collection module and the quality monitoring subsystem QMS works normally and marks a working system.

According to a second aspect of the present invention, provided is a system applying the signal system switchover method, comprising the new system control center, the self-synchronization subsystem TAS, the old system control center, the panoramic cockpit HMS, the quality monitoring subsystem QMS, the central data lake, the line data pool, the trackside system, and the vehicle system, wherein the old system control center synchronizes a plan to the new system control center through the self-synchronization subsystem TAS, and data of the trackside system and the vehicle system are transmitted to the panoramic cockpit HMS through the line data pool, the central data lake and the quality monitoring subsystem QMS, respectively.

As a preferred technical scheme, the self-synchronization subsystem TAS is configured to synchronize the official operation plan of the old system control center to the new system control center.

As a preferred technical scheme, the quality monitoring subsystem QMS comprises an automatic data collection module, an automatic data analysis module, and an automatic quality assessment module.

As a preferred technical scheme, the panoramic cockpit HMS comprises a large quality monitoring screen and an abnormal emergency alarm module.

As a preferred technical scheme, the trackside system comprises a trackside switchover subsystem WDS and a new trackside device and an old trackside device that are connected to the trackside switchover subsystem WDS in a switching manner.

As a preferred technical scheme, the vehicle system comprises an on-board switchover subsystem ODS and a new on-board device and an old on-board device that are connected to the on-board switchover subsystem ODS in a switching manner.

According to third aspect of the present invention, provided is an electronic device, comprising a processor and a memory on which a computer program is stored, wherein the processor, when executing the program, implements the above method.

According to fourth aspect of the present invention, provided is a computer-readable storage medium on which a computer program is stored, wherein the program, when executed by a processor, implements the above method.

Compared with the prior art, the present invention has the following advantages:
1) When the old system controls the train during the operation time, in the present invention, the new system intervenes in the operation in the shadow mode in advance, realizes the monitoring of the whole operation scene, and verifies the capacity and reliability of the new system without affecting the safety and efficiency of the operation;
2) The present invention improves the safety of the switchover scheme through a plurality of safety isolation designs; and
3) The present invention realizes automatic collection of operation data, automatic analysis and evaluation of operation quality.

### BRIEF DESCRIPTION OF THE DRAWINGS

FIG. 1 is a flow chart of a signal system switchover method of the present invention; and

FIG. 2 is an architecture diagram of a signal system switchover system of the present invention; and

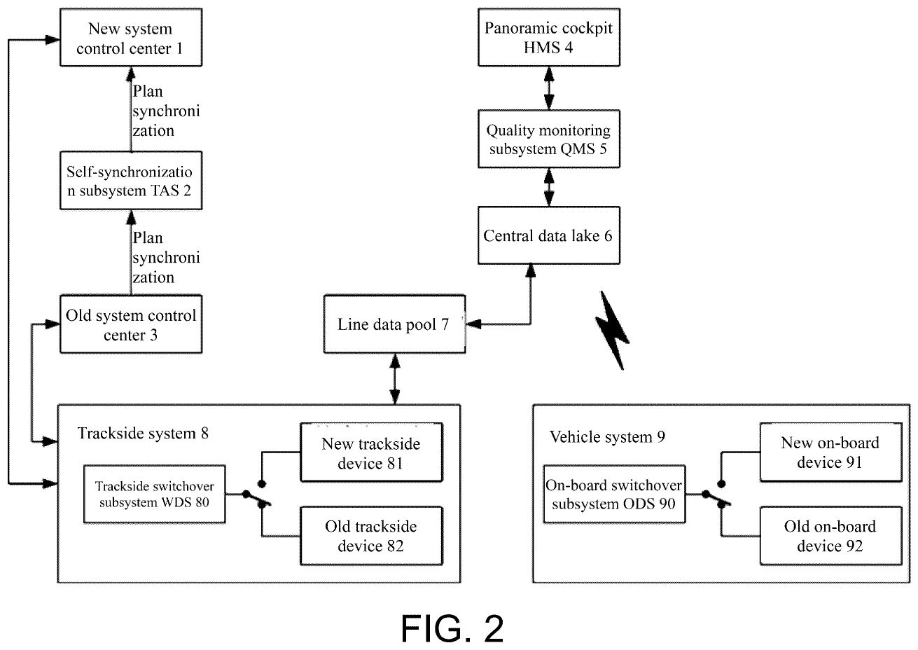

Reference numbers in FIG. 2 are shown as follows:

1. new system control center, 2. self-synchronization subsystem TAS, 3. old system control center, 4. panoramic cockpit HMS, 5. quality monitoring subsystem QMS, 6. central data lake, 7. line data pool, 8. trackside system, 80. trackside switchover subsystem WDS, 81. new trackside device, 82. old trackside device, 9. vehicle system, 90. on-board switchover subsystem ODS, 91. new on-board device, 92. old on-board device.

### DETAILED DESCRIPTION OF THE INVENTION

The following is a clear and complete description of technical schemes in embodiments of the present invention in combination with drawings attached to the embodiments of the present invention. Obviously, the embodiments described is a part of the embodiments of the present invention, but not the whole embodiments. Based on the embodiments of the present invention, all other embodiments obtained by an ordinary skilled person in the art without creative labor shall fall within a protection scope of the present invention.

Provided in the present invention is a signal system switchover method, which can also be used for other professional upgrading and transformation in the field of rail transit and related industrial control. By placing a working state of the signal system in an old system working state and a new system shadow operating state, one-time service quality of the new system can be ensured after the switchover.

The shadow operating state means that after the new system is loaded with an official operation plan, operating data of the line and train is obtained only when the signal system is officially operated and the old system works normally, and the new system does not participate in any device control or train safety protection work.

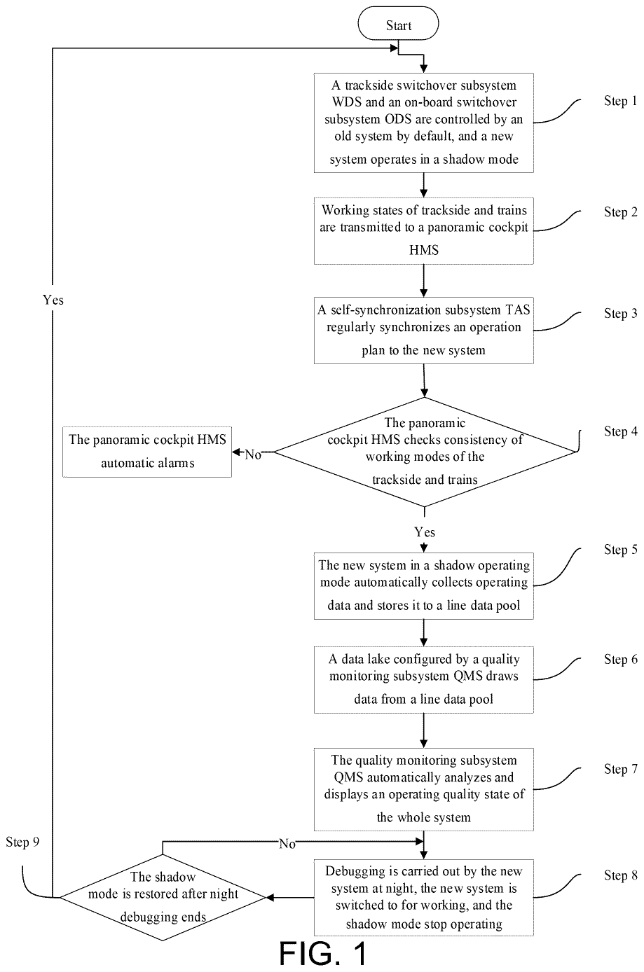

As shown in FIG. 1, the switchover method specifically comprises the following steps:
Step 1: after the system is started, a default working state of switchover subsystems WDS and ODS is that the old system works and the new system is placed in a shadow mode operating state.
Step 2: the new system collects working states of all trackside and trains of the new system in a whole line and transmit to a panoramic cockpit HMS 4;
Step 3: before start of daytime operation, a self-synchronization subsystem TAS 2 regularly synchronizes an official daytime operation plan of the old system and loads it into the new system;
Step 4: during the daytime operation, the old system is responsible for control of a trackside device, safety protection and operation control of the train operation, while the new system is operated after obtaining states of the line and train in an active following mode, and the panoramic cockpit HMS 4 checks working modes of the all-line trackside and all trains. the panoramic cockpit HMS 4 automatically alarms when each trackside switchover subsystem WDS 80 and on-board switch subsystem ODS 90 are in inconsistent working modes or faulty;
Step 5: during the daytime operation, an automatic data collection module of the new system in a shadow operating mode automatically provides the operating data to a line data pool 7 set in the trackside for storage, and the trackside device and train do not accept any data transmitted by the line data pool 7;
Step 6: a central data lake 6 configured by a quality monitoring subsystem QMS 5 draws data from the line data pool 7, the data from line data pool 7 can only be unidirectionally provided to the central data lake 6, and the line data pool 7 does not accept the data from the central data lake 6;
Step 7: the quality monitoring subsystem QMS 5 automatically analyzes a full-time domain operating quality state of the new system based on the data of the central data lake 6, and provides it to a monitoring engineer through the panoramic cockpit HMS 4;
Step 8: during debugging of the new system at night, the working mode of the new system is switched to through the trackside switchover subsystem WDS 80 and the on-board switchover subsystem ODS 90, the shadow mode stops the operation, and the automatic data collection module and the quality monitoring subsystem QMS 5 still work normally, but need to mark a working system; and
Step 9: after the night debugging ends, a default control state of the old system is switched to through the trackside switchover subsystem WDS 80 and the on-board switchover subsystem ODS 90, and the new system works in the shadow mode.

The automatic alarm is given when the switchover devices are inconsistent in the working mode states or faulty.

The above is the introduction of the method embodiments, and the schemes of the present invention are further explained by system embodiments.

Also provided in the present invention is a signal system switchover system. As shown in FIG. 2, the system comprises a new system control center 1, a self-synchronization subsystem TAS 2, an old system control center 3, a panoramic cockpit HMS 4, a quality monitoring subsystem QMS 5, a central data lake 6, a line data pool 7, a trackside system 8, and a vehicle system 9, wherein the old system control center 3 synchronizes a plan to the new system control center 1 through the self-synchronization subsystem TAS 2, and data of the trackside system 8 and the vehicle system 9 are transmitted to the panoramic cockpit HMS 4 through the line data pool 7, the central data lake 6 and the quality monitoring subsystem QMS 5, respectively. The trackside system 8 comprises a trackside switchover subsystem WDS 80, a new trackside device 81 and an old trackside device 82; the vehicle system 9 comprises an on-board switchover subsystem ODS 90, a new on-board device 91 and an old on-board device 92. The trackside switchover subsystem WDS 80 and the on-board switchover subsystem ODS 90 both comprise a safety isolation method and a corresponding module, a working mode monitoring module and a fault alarm indication; the quality monitoring subsystem QMS 5 comprises an automatic data collection module based on a total isolation of a private network, a line data pool and a central data lake, an automatic data analysis module based on a fast self-matching algorithm and self-learning ability, and an automatic quality assessment module; and the cockpit is consisted of a large quality monitoring screen and an abnormal emergency alarm module.

The system is used in a signal transformation project of Shanghai Rail Transit Line 3/4, which effectively solves the problem of insufficient debugging and verification time of the transformation project. With the shadow mode activated during the daytime operations, the states of all new system trackside devices and vehicle devices can be displayed in real-time in the panoramic cockpit. The shadow mode is used to complete a stress test of a maximum number of trains in operation and verification of operating stability of the whole system. By collecting massive new system operating data during a large amount of daytime operation time in parallel and conducting automatic evaluation of the operating quality, system performance can be continuously improved to ensure high-quality opening and operation of the new system.

A technical person in the field can clearly understand that for the convenience and simplicity of description, a specific working process of the described module may refer to a corresponding process in the above-mentioned embodiments of the method, and will not be repeated herein.

The electronic device of the present invention comprises a central processing unit (CPU) that can perform various appropriate actions and processes according to computer program instructions stored in a read-only memory (ROM) or loaded from a storage unit into a random access memory (RAM). In the RAM, various programs and data required for an operation of the device can also be stored. The CPU, ROM, and RAM are connected to each other via a bus. An input/output (I/O) interface is also connected to the bus.

A plurality of components in the device are connected to the I/O interface, comprising: input units, such as a keyboard and a mouse; output units, such as various types of displays and speakers; storage units, such as a disk and an optical disc; and communication units, such as a network card, a modem and a wireless communication transceiver. The communication unit allows the device to exchange information/data with other devices through a computer network such as the Internet and/or various telecommunications networks.

The processing unit performs each of the methods and processes described above, such as methods of the present invention. For example, in some embodiments, the methods of the present invention may be realized as a computer software program that is physically contained in a machine-readable medium, such as a storage unit. In some embodiments, parts or all of the computer program may be loaded and/or installed on the device via the ROM and/or the communication unit. When the computer program is loaded into the RAM and executed by the CPU, one or more steps of the above-mentioned methods of the present invention can be performed. Alternatively, in other embodiments, the CPU may be configured to execute the methods of the present invention by any other appropriate manner (e.g., with the help of a firmware).

The functions described above herein can be performed, at least in part, by one or more hardware logical components. For example, without limitation, demonstration types of hardware logic components that can be used comprise: a field programmable gate array (FPGA), an application-specific integrated circuit (ASIC), an application-specific standard product (ASSP), a system-on-chip (SOC), a complex programmable logic device (CPLD), and so on.

The program codes for implementing the method of the present invention may be written in any combination of one or more pieces of programming language. These program codes may be provided to a processor or controller of a general-purpose computer, a special-purpose computer or another programmable data processing device so that the program codes, when executed by the processor or controller, implements the functions/operations specified in the flow chart and/or block diagram. The program codes can be executed entirely on a machine, partially on a machine, partially on a machine and partially on a remote machine or completely on a remote machine or server as a stand-alone software package.

In the context of the present invention, the machine readable medium may be a tangible medium that may contain or store a program for use by or in conjunction with an instruction executing system, apparatus or device. The machine readable medium may be a machine readable signal medium or a machine readable storage medium. The machine readable medium may comprise, but is not limited to, an electronic, magnetic, optical, electromagnetic, infrared, or semiconductor system, apparatus, or device, or any suitable combination of the above. More specific examples of the machine readable storage medium would comprise an electrical connection based on one or more wires, a portable computer disk, a hard disk, a random access memory (RAM), a read-only memory (ROM), an erasable programmable ROM (EPROM or flash memory), an optical fiber, a convenient compact disk ROM (CD-ROM), an optical storage device, a magnetic storage device, or any suitable combination of the above.

The above are only specific embodiments of the present invention, but the protection scope of the present invention is not limited to this, and any technical person familiar with the technical field can easily think of various equivalent modifications or replacements within the technical scope disclosed by the present invention, which shall be covered by the protection scope of the present invention. Therefore, the protection scope of the present invention shall be subject to the protection scope of the claims.

1. A signal system switchover method, implemented based on an active following shadow mode and full-time domain quality monitoring, and specifically comprising following steps:
step S1: a signal system is started, a working state is set to an old system working state and a new system shadow operating state, and step S2 is executed;
step S2: when the signal system is officially put into operation, an old system carries out normal operating control, and a new system obtains operating data of a line and a train, and step S3 is executed;
step S3: an automatic data collection module provides the operating data obtained by the new system to a trackside line data pool (7), and a line data pool (7) provides the operating data to a central data lake (6), step S4 is executed;
step S4: a quality monitoring subsystem QMS (5) automatically analyzes operating quality according to the operating data in the central data lake (6) and transmits a result to a panoramic cockpit HMS (4), and step S5 is executed; and
step S5: when debugging the signal system, the working state is set to a new system working state.

2. The signal system switchover method according to claim 1, wherein the signal system in step S1 transmits working states of an all-line trackside system (8) and a vehicle system (9) to the panoramic cockpit HMS

3. The signal system switchover method according to claim 1, wherein in the step S2, before the signal system is officially put into operation, an old system control center (3) synchronizes an official operation plan to a new system control center (1) through a self-synchronization subsystem TAS (2).

4. The signal system switchover method according to claim 1, wherein when the signal system in step S2 is officially put into operation, the panoramic cockpit HMS (4) checks the working states of an all-line trackside system (8) and a vehicle system (9), and automatically alarms if any device is in the new system working state.

5. The signal system switchover method according to claim 1, wherein in step S3, the line data pool (7) unidirectionally receives the operating data of a trackside system (8) and a vehicle system (9).

6. The signal system switchover method according to claim 1, wherein in step S3, the data of the line data pool (7) is unidirectionally fed to the central data lake (6).

7. The signal system switchover method according to claim 1, wherein in step S4, the quality monitoring subsystem QMS (5) carries out analysis based on data from the central data lake (6).

8. The signal system switchover method according to claim 1, wherein in the step S5, during debugging of the signal system, the automatic data collection module and the quality monitoring subsystem QMS (5) works normally and marks a working system.

9. A system applying the signal system switchover method according to claim 1, comprising a new system control center (1), a self-synchronization subsystem TAS (2), an old system control center (3), the panoramic cockpit HMS (4), the quality monitoring subsystem QMS (5), a central data lake (6), the line data pool (7), a trackside system (8), and a vehicle system (9), wherein the old system control center (3) synchronizes a plan to the new system control center (1) through the self-synchronization subsystem TAS (2), and data of the trackside system (8) and the vehicle system (9) are transmitted to the panoramic cockpit HMS (4) through the line data pool (7), the central data lake (6) and the quality monitoring subsystem QMS (5), respectively.

10. The system according to claim 9, wherein the self-synchronization subsystem TAS (2) is configured to synchronize the official operation plan of the old system control center (3) to the new system control center (1).

11. The system according to claim 9, wherein the quality monitoring subsystem QMS (5) comprises an automatic data collection module, an automatic data analysis module, and an automatic quality assessment module.

12. The system according to claim 9, wherein the panoramic cockpit HMS (4) comprises a large quality monitoring screen and an abnormal emergency alarm module.

13. The system according to claim 9, wherein the trackside system (8) comprises a trackside switchover subsystem WDS (80) and a new trackside device (81) and an old trackside device (82) that are connected to the trackside switchover subsystem WDS (80) in a switching manner.

14. The system according to claim 9, wherein the vehicle system (9) comprises an on-board switchover subsystem ODS (90) and a new on-board device (91) and an old on-board device (92) that are connected to the on-board switchover subsystem ODS (90) in a switching manner.

15. An electronic device, comprising a processor and a memory on which a computer program is stored, wherein the processor, when executing the program, implements the method according to claim 1.

16. An non-transitory computer-readable storage medium on which a computer program is stored, wherein the program, when executed by a processor, implements the method according to claim 1
